(19) United States
(12) Patent Application Publication
(10) Pub. No.: US 2013/0026860 A1
(43) Pub. Date: Jan. 31, 2013

(54) VIBRATION-GENERATING DEVICE

(71) Applicant: Young Jae JEON, Gyunggi-do (KR)

(72) Inventor: Young Jae JEON, Gyunggi-do (KR)

(73) Assignee: SAMSUNG ELECTRO-MECHANICS CO., LTD., Gyunggi-do (KR)

(21) Appl. No.: 13/301,497

(22) Filed: Nov. 21, 2011

(30) Foreign Application Priority Data
Jul. 29, 2011 (KR) 10-2011-0075921

(51) Int. Cl. H02K 33/00

(52) U.S. Cl. 310/25

(57) ABSTRACT

Disclosed herein is a vibration-generating device. The vibration-generating device including: a stator including a case, a coil and a bracket; a vibrator including a weight body, a magnet, a yoke and a plate yoke; and an elastic member arranged at an upper portion of the vibrator, wherein the weight body includes a groove part formed in an upper portion thereof so as to be opposite to the elastic member.

### CROSS REFERENCE TO RELATED APPLICATION

This application claims the benefit of Korean Patent Application No. 10-2011-0075921, filed on Jul. 29, 2011, entitled “Vibration-Generating Device,” which is hereby incorporated by reference in its entirety into this application.

### BACKGROUND OF THE INVENTION

1. Technical Field

The present invention relates to a vibration-generating device.

2. Description of the Related Art

Recently, various types of vibration-generating devices are being mounted on portable electronic devices such as a mobile phone, a game console, and a portable information terminal, etc., in order to prevent damage to others by external sound.

Particularly, such a vibration-generating device, which is mounted on a mobile phone, is used as an anacoustic received signal generation device (including haptic vibration), and improvement in noise and durability of a vibration-generating device mounted on the mobile phone is required as such a mobile phone gets smaller and slimmer.

A vibration-generating device according to a prior art includes a spring member, a weight body, and a bracket, etc., and there is a possibility that noise by a touch between a spring member and a weight body or between a bracket and a weight body is generated.

Further, the prior art has a problem in that a product can be deformed by a touch between a case and a spring member and between a bracket and a weight body.

### SUMMARY OF THE INVENTION

The present invention has been made in an effort to provide a vibration-generating device capable of reducing noise and improving durability.

According to a preferred embodiment of the present invention, there is provided a vibration-generating device, including: a stator including a case, a coil and a bracket; a vibrator including a weight body, a magnet, a yoke and a plate yoke; and an elastic member arranged at an upper portion of the vibrator, wherein the weight body includes a groove part formed in an upper portion thereof so as to be opposite to the elastic member.

The weight body may be provided with a protrusion part protruded at an outer portion of the groove part to thereby function as a stopper against the elastic member.

The weight body may include a damper formed at the lower portion thereof so as to minimize friction with the bracket.

### BRIEF DESCRIPTION OF THE DRAWINGS

FIG. 1 is a cross-sectional view of a vibration-generating device 100 according to a preferred embodiment of the present invention; and

FIG. 2 is a partially enlarged view of a vibration-generating device 100 according to a preferred embodiment of the present invention.

### DESCRIPTION OF THE PREFERRED EMBODIMENTS

Various objects and advantages of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention. Further, when it is determined that the detailed description of the known art related to the present invention may obscure the gist of the present invention, the detailed description will be omitted.

Hereinafter, the preferred embodiments of the present invention will be described in detail with reference to the accompanying drawings.

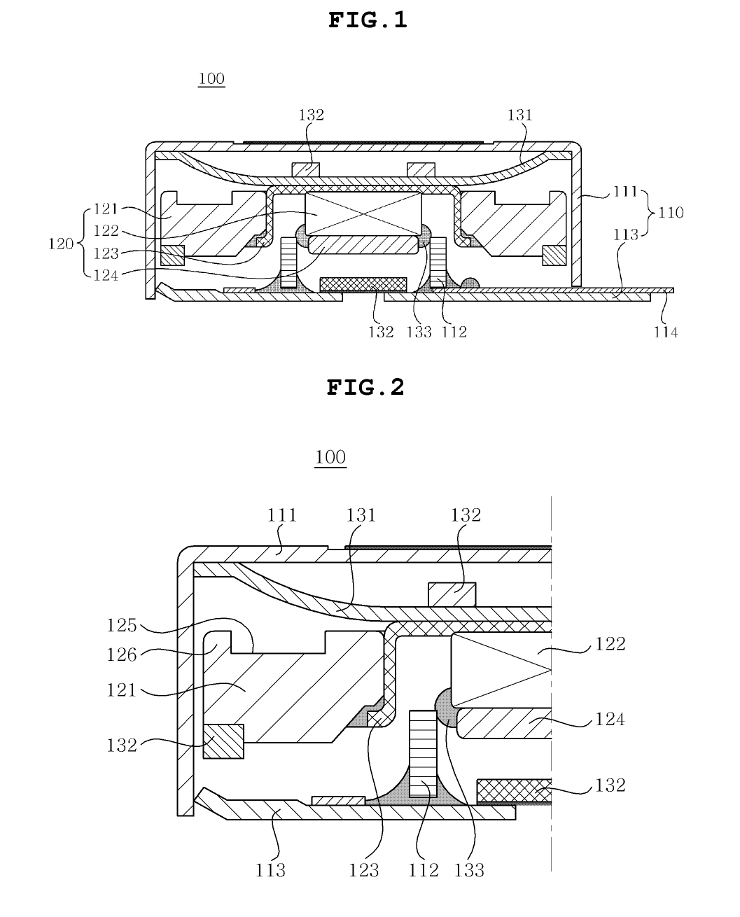

FIG. 1 is a cross-sectional view of a vibration-generating device 100 according to a preferred embodiment of the present invention, and FIG. 2 is a partially enlarged view of a vibration-generating device 100 according to a preferred embodiment of the present invention.

As shown in FIG. 1, a vibration-generating device 100 according to a preferred embodiment of the present invention is configured to include a stator 110 including a case 111, a coil 112 and a bracket 113, a vibrator 120 including a weight body 121, a magnet 122, a yoke 123 and a plate yoke 124, an elastic member 131, a damper 132 and a magnetic fluid 133.

The case 111, which forms the internal space of the vibration-generating device 100 therein, protects built-in components from the outside. The case 111 may be made of ferrous material, and the elastic member 131 is fixed on an upper edge of the case 111.

The coil 112, which is mounted on an upper portion of the bracket 113 supporting a lower surface of the case 111, is arranged to be opposite to the magnet 122 to generate electromagnetic force, thereby vibrating the vibrator 120.

The bracket 113 supports the lower surface of the case 111 and has a FPC 114 mounted on an upper portion thereof to thereby apply an electrical signal to the vibration-generating device 100.

The case 111, the coil 112, and the bracket 113 configure the stator 110 of the vibration-generating device 100.

The weight body 121 is mounted in the case 111 and receives an electrical signal to thereby vertically vibrate. The weight of the weight body has an influence on vibratory force.

The magnet 122 is mounted at a central portion of the yoke 123 and is mounted to be opposite to the coil 112 to thereby generate electromagnetic force.

The yoke 123 supports the weight body 121 and the magnet 122 and has an upper end connected to the elastic member 131 to thereby support vertical vibration of the vibrator 120.

The plate yoke 124 is mounted on a lower end of the magnet 122 to thereby support the lower end of the magnet.

The weight body 121, the magnet 122, the yoke 123 and the plate yoke 124 configure the vibrator 120 of the vibration-generating device 100.

The elastic member 131 is fixed to the upper edge of the case 111 to thereby support the vertical vibration of the vibrator 120. A leaf spring is generally used as the elastic member 131.

The damper 132 is mounted on an upper surface of the elastic member 131 to thereby prevent friction between the elastic member 131 and the case 111 at the time of vertical vibration of the elastic member 131.

The damper 132 is also mounted on an upper portion of the bracket 113 to thereby prevent friction between the plate yoke 124 and the bracket 113.

The magnetic fluid 133, which is magnetic liquid, is mounted on the FPC 114 to thereby prevent friction between the FPC 114 and other components.

FIG. 2 is a partially enlarged view of a vibration-generating device 100 according to a preferred embodiment of the present invention. The weight body 121 is provided with a groove part 125 to thereby prevent friction with the elastic member 131 arranged at an upper portion thereof at the time of vertical vibration of the weight body 121.

A shape and a position of the groove part 125 are not limited; however, the groove part 125 may be formed in various shapes in a position opposite to the elastic member 131 at an upper central portion of the weight body 121.

The groove part 125 is formed in various shapes so as to prevent friction and contact with the elastic member 131 bent downwardly.

The groove part 125 is provided with a protrusion part 126 formed at an outer portion thereof, wherein the protrusion part 125 functions as a stopper against the elastic member 131 at the time of the vertical vibration of the weight body 121.

Hence, the weight body 121 includes the groove part 125 and the protrusion part 126 formed at the upper portion thereof to thereby minimize friction and abrasion with the elastic member 131 arranged over the weight body 121.

Further, the weight body 121 includes the damper 132 provided at a lower portion thereof in order to prevent friction and contact with the bracket 113.

The damper 132 is mounted on an upper portion of the elastic member 131 to prevent friction between the case 111 and the elastic member 131, and is also mounted at the lower portion of the weight body 121 to thereby prevent friction and contact between the bracket 113 and the weight body 121.

As set forth above, the vibration-generating device 100 having the above-described configuration according to the present invention includes the groove part 125 and the protrusion 126 provided at the weight body 121, thereby minimizing friction between the weight body 121 and the elastic member 131. Hence, noise and abrasion due to friction are minimized, thereby making it possible to improve performance of the vibration-generating device 100.

Further, the damper 132 is mounted at the lower portion of the weight body 121 to prevent friction and contact between the weight body 121 and the bracket 113, thereby making it possible to minimize noise and abrasion generated at the time of driving of the vibration-generating device 100.

Although the preferred embodiments of the present invention have been disclosed for illustrative purposes, they are for specifically explaining the present invention and thus a vibration-generating device according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A vibration-generating device, comprising:
a stator including a case, a coil and a bracket;
a vibrator including a weight body, a magnet, a yoke and a plate yoke; and
an elastic member arranged at an upper portion of the vibrator,
wherein the weight body includes a groove part formed in an upper portion thereof so as to be opposite to the elastic member.

2. The vibration-generating device as set forth in claim 1, wherein the weight body is provided with a protrusion part protruded at an outer portion of the groove part to thereby function as a stopper against the elastic member.

3. The vibration-generating device as set forth in claim 1, wherein the weight body includes a damper formed at the lower portion thereof so as to minimize friction with the bracket.
